(19) United States
(12) Patent Application Publication
(10) Pub. No.: US 2026/0307751 A1
(43) Pub. Date: Oct. 8, 2026

(54) ACCESSIBLE ASSEMBLY STATION, IN PARTICULAR ASSEMBLY PLATFORM, AND METHOD FOR OPERATING THE SAME

(71) Applicant: FFT PRODUKTIONSSYSTEME GMBH & CO. KG, Fulda (DE)

(72) Inventors: Nils Kramm, Fulda (DE); Jan Kreuzer, Schlitz-Pforct (DE)

(73) Assignee: FFT PRODUKTIONSSYSTEME GMBH & CO. KG, Fulda (DE)

(21) Appl. No.: 19/480,490

(22) PCT Filed: Apr. 5, 2024
(86) PCT No.: PCT/EP2024/059364

§ 371 Date: Oct. 31, 2025

(30) Foreign Application Priority Data
May 3, 2023 (DE) 10 2023 111 504.9

(51) Int. Cl. B62D 65/18

(52) U.S. Cl. CPC B62D 65/18

(57) ABSTRACT

An assembly station through which a workpiece arranged on a transport device can be moved on a defined transport path in a transport direction. The assembly station including: a first conveying slot formed between a first platform and a third platform, and a second conveying slot formed between a second platform and the third platform. The longitudinal directions of the conveying slots define the transport path; and a plurality of holding devices which can each assume a holding position in which they hold the third platform in position in relation to the first or second platform. The holding devices can be moved into a release position in which they allow the transport device together with the workpiece to move through the assembly station.

### CROSS-REFERENCE TO RELATED APPLICATIONS

This is the U.S. National Phase application of PCT/EP2024/059364, filed Apr. 5, 2024 which claims priority to German Patent Application No. 10 2023 111 504.9, filed May 3, 2023, the disclosures of these applications being incorporated herein by reference in their entireties for all purposes.

### FIELD OF THE INVENTION

The invention relates to an assembly station, in particular an assembly platform, which can be accessed by one or more persons, in particular machine operators or assembly operators, for example in the assembly-line production of motor vehicles. The invention also relates to a method for operating such an assembly station. The accessible assembly station can be part of an assembly system in which an autonomous motorised driverless transport vehicle supplies a workpiece, for example a vehicle body, and moves through the assembly station, during which time the persons are able to work on the workpiece.

### BACKGROUND OF THE INVENTION

DE 10 2017 103 931 A1, incorporated herein by reference, describes a driverless transport vehicle which comprises an assembly platform and can pass through individually different sequences of processing stations.

DE 10 2019 132 553 A1, incorporated herein by reference, discloses a vehicle for simultaneously transporting workpieces and machine operators. The vehicle comprises an assembly platform on which the machine operators are also conveyed. The assembly platform is composed of a plurality of segments which are movably connected to each other and have at least one wheel via which they are supported on a movement surface during operation.

DE 10 2019 129 801 A1, DE 10 2006 059 886 A1 and DE 10 2005 034 582 A1, each incorporated herein by reference, disclose conveying systems for simultaneously transporting workpieces and machine operators.

A transport system for production lines, in which a free space formed between two consecutively moving assembly platforms is at least partially covered by a bridging element is described in DE 10 2018 130 221 A1, incorporated herein by reference.

WO 2022/162530 A1, incorporated herein by reference, proposes a transport system in which a frame which supports an object to be transported is delivered by an autonomously moving motorised carriage (automated guided vehicle or AGV) to an unloading station, where it is transferred for example to a fixedly installed production line or loaded at a loading station from which it is transported away. Unlike fixedly installed production lines, AGVs can perform flexible transport tasks.

### SUMMARY OF THE INVENTION

An aspect of the invention is based on the aim of specifying an assembly station which allows a driverless transport vehicle (automated guided vehicle) to be integrated into the assembly-line production and into the assembly process and allows a safely accessible assembly platform to be provided. An aspect of the invention is also based on specifying a method for operating an assembly station.

An aspect of the invention is based on an assembly station, in particular an assembly platform, which can be assembled so as to be spatially fixed in relation to the production building or the floor of the production building. A workpiece arranged on a transport device, such as for example a vehicle body part, a chassis of a motor vehicle, a household appliance or other device to be manufactured or assembled in series production, is moved through the assembly station on a defined transport path in a transport direction. The transport device moves relative to the assembly station but is not part of the assembly station, although the transport device is designed to co-operate with the assembly station. An assembly system can comprise such an assembly station and at least one such transport device.

The transport device can be designed as a transport vehicle, in particular an autonomous or automated driverless transport vehicle. Such vehicles are generally referred to as AGVs. The vehicle can in particular be a transport vehicle designated as FFTigv by the Applicant.

The assembly station comprises a first, second and third platform which can be accessed in particular by an assembly operator or a machine operator or generally by a person. The first and second platforms can each be supported on the floor via a frame and can be raised or elevated above the floor. From the platform, the assembly operator or machine operator can work on the workpiece or perform assembly tasks on the workpiece as it moves through the assembly station, i.e. in the transport direction relative to the platforms. The workpiece, or a workpiece support on which the workpiece is or can be arranged, is situated above the upper side of the platform, wherein the transport device itself is situated below the platform. The transport device can be connected to the workpiece or the workpiece support by means of one or more connecting structures. Where the connecting structure penetrates the plane of the platform, a gap such as for example a slot or channel between two adjacent platforms is in principle required in order to move the workpiece arranged on the transport device in the transport direction. If only one such slot is provided, the platforms between which the slot is formed can each be supported on the floor, for example by means of a frame. In such an embodiment, the at least one connecting structure can extend from the transport device to the workpiece through this slot only. The forces and moments exerted on the workpiece during assembly must then be dissipated to the transport device situated below the platform via this connecting structure. The connecting structure must be correspondingly stable. In particular when workpieces are heavy or subjected to loads on one side, significant stability demands are made on said connecting structure. At the same time, a certain deformation of the connecting structure cannot readily be avoided, such that the workpiece appears to wobble or tends to oscillate, in particular when the slot width is to be kept narrow, which requires a narrow embodiment of the connecting structure.

In order to increase stability, it would in principle be possible to embody the at least one connecting structure to be wider or to provide a plurality of connecting structures which are spaced from each other transversely to the transport direction. However, this would then make the slot width larger and/or large enough that it is no longer possible for a person to step over the slot or not without significant risk of injury. It is therefore desirable to keep the slot width small.

The assembly station therefore contains a first conveying slot, which is formed between the first and third platforms, and a second conveying slot which is formed between the second and third platforms. The first conveying slot and the second conveying slot are for example spaced from each other and arranged parallel to each other. The third platform can be situated between the conveying slots. The first conveying slot is provided for at least one first connecting structure, and the second conveying slot is provided for at least one second connecting structure. The longitudinal directions of the conveying slots define the transport path. The first and second connecting structures, which protrude upwards from the transport device, can be arranged at a distance from each other in a direction transverse to the transport path or transverse to the longitudinal direction of the conveying slots, thus more effectively supporting the workpiece on the transport device. The connecting structures themselves can thus be embodied to be relatively narrow, which enables the slot width to also be embodied to be relatively narrow. The advantage which this achieves is that it is readily possible to step over the slots without risk of injury, such that the slots in particular satisfy the safety regulations for accident prevention, such as for example those relating to the safety of machine operators when traversing platforms in accordance with DIN EN ISO 14122-3. The slot width can for example be less than 10 cm or less than 5 cm or about 2.5 cm, wherein the slot width is however large enough that the respective connecting structure can protrude through it, in particular with a clearance from the flanks of the slot which are formed by the first and third platform or, respectively, by the second and third platform. In an example in which the slot width measures about 2.5 cm, the width of the at least one connecting structure can be less than 2 cm or can for example measure about 1 cm.

The first, second and third platforms can for example be embodied such that an assembly operator can walk around the workpiece on the upper surfaces of the platforms which are in particular embodied to be planar or flat.

Since the third platform is separated from the first and second platforms by the first and second conveying slots, and the transport path for the transport device is situated below the third platform, it is necessary for the third platform to be held in position. The assembly station comprises a plurality of holding devices, which are each configured to be able to assume a holding position in which they are for example in a positioning engagement and in which they hold the third platform in position in relation to the first or second platform, in particular with respect to the direction of gravity (Z direction) and/or horizontally transverse to the transport direction (Y direction) and/or in the transport direction (X direction). In their respective holding position, the holding devices can for example cross at least one of the conveying slots. The holding devices can in particular cross at least one of the conveying slots on the lower side of the platforms or below the platforms. The holding devices can be arranged between the transport device and the lower side of the platforms. Alternatively, it is possible for the holding devices to be arranged in the conveying slot and/or to cross the conveying slot in the conveying slot. The holding devices enable the third platform to be held in position in relation to the first and second platforms, in particular in the X, Y and Z directions, and the forces exerted on the third platform to be dissipated into the first and/or second platform or into the at least one frame via which the first and second platforms are supported on the floor.

In embodiments, the holding devices in their respective holding position restrict or block the ability of the connecting structures to move through the first and second conveying slots, hence in the absence of further measures, it would not be possible or only possible to a limited extent for the workpiece to move in the transport direction on the defined transport path.

The holding devices can each be moved from their holding position to a release position in which the respective positioning engagement is released. In embodiments, the holding devices can be moved into a release position in which they expose or do not cross the conveying slot which they cross in their respective holding position. The connecting structures can thus move unhindered in the transport direction where the holding devices are in their release position.

The assembly station in accordance with an aspect of the invention ensures that the workpiece arranged on a transport device, in particular an automated driverless transport vehicle, can be moved through the assembly station, in particular from an entrance to an exit of the assembly station, without having to be transferred, and worked on in the process. The transport device can thus be easily integrated into the assembly-line production, and the assembly tasks to be performed on the assembly platform can be performed in a way which is safe for the machine operator or assembly operator. In order to improve occupational safety, it is advantageous for the first, second, and third accessible platforms and/or their upper sides to lie in a common or at least substantially common horizontal plane. This avoids a risk of tripping. It is also preferable for the first and second conveying slots to exhibit a limited slot width, in particular one of the aforementioned slot widths. This prevents a machine operator's foot or foreign objects, in particular component parts, tools, assembly waste or packaging residues, from being able to fall into or through the conveying slot, which could for example disrupt a sensor system of the transport device or a controller of the holding devices. It is in principle optionally possible to provide covering elements or elastic elements, such as for example one or more brushes, in the conveying slots which can for example elastically yield to the connecting structure when the latter moves through the conveying slot in the transport direction. The elastic elements can additionally cover the conveying slot, although they do not perform any holding tasks for the third platform. By additionally covering the conveying slot, the elastic elements can even more effectively prevent foreign objects, in particular even small foreign objects such as for example chips, from being able to fall into or through the conveying slot.

In developments, a plurality of holding devices can be provided which, in their holding position, cross the first conveying slot and hold the third platform in position in relation to the first platform and, in their release position, expose or do not cross the first conveying slot, in particular in order for the connecting structure to move in the longitudinal direction of the conveying slot. The same can apply analogously to the second conveying slot, i.e. a plurality of holding devices can be provided which, in their holding position, cross the second conveying slot and hold the third platform in position in relation to the second platform and, in their release position, expose or do not cross the second conveying slot in order for a connecting structure to move in the longitudinal direction of the second conveying slot.

The holding devices, in their respective release position, can for example enable at least one connecting structure, which connects the transport device (which can be moved along the transport path below the third platform) to the workpiece (which is arranged above the third platform) and extends through the first and/or second conveying slot, to move along the transport path in the transport direction in the conveying slot or slots. It is in principle possible to connect the workpiece to the transport device via at least one connecting structure which extends through the first or second conveying slot only, wherein the other conveying slot remains empty. While this may compromise stability, it enables a transport device to move flexibly through the assembly station, even if it only comprises one connecting structure, which can be perfectly sufficient in particular for light workpieces. Optionally, the at least one connecting structure can be moved through the first or second conveying slot. In particular when workpieces are heavy or subjected to uneven loads, however, at least one first connecting structure can be provided which extends through the first conveying slot, and at least one second connecting structure can be provided which extends through the second conveying slot.

The assembly station or the holding devices are configured such that a plurality of the holding devices are always simultaneously in their holding position. This ensures that the third platform is securely held in position in relation to the first and second platforms, in particular including when other holding devices are in their release position. It is for example advantageous for a plurality of holding devices which cross the first conveying slot in their holding position and a plurality of holding devices which cross the second conveying slot in their holding position to simultaneously be in their holding position, even when other holding devices assigned to the first conveying slot and the second conveying slot are in their respective release position.

The holding devices can for example be configured such that the maximum number of holding devices which are in or can be moved into the release position is such that the third platform is held in position, in particular stably, by holding devices which are situated in the holding position and in particular assigned to the first conveying slot and/or the second conveying slot. This ensures on the one hand that the workpiece can be moved along the transport path in the transport direction through the assembly station and, on the other hand, that the third platform can be safely accessed by a machine operator without the third platform tilting or moving in an undesired manner.

In developments, the holding devices or at least some of the holding devices can be able to be linearly moved between the holding position and the release position. More specifically, the holding devices or some of them can each comprise an elongated structure, in particular a piston rod, which can be linearly moved back and forth between the holding position and the release position. Alternatively or additionally, the holding devices or at least some of the holding devices can be able to be pivoted about a pivot axis between the holding position and the release position. More specifically, the holding devices or some of them can each comprise a support, in particular an arm-shaped support, which can be pivoted back and forth about the pivot axis between the holding position and the release position. Hybrid forms are also conceivable in which some of the holding devices or their elongated structures or piston rods can be linearly moved between the holding position and the release position, and some of the other holding devices or their supports, in particular arm-shaped supports, can be pivoted about a pivot axis between the holding position and the release position. Irrespective of whether they can be linearly moved or pivoted, the holding devices can in particular be able to move from the holding position to the release position and from the release position to the holding position.

The holding devices or at least some of the holding devices can be designed as supporting devices which, in the respective holding position, support the third platform at least downwards in the direction of gravity (Z direction). This prevents the third platform from falling downwards, i.e. towards the floor.

The holding devices or at least some of the holding devices can be designed as positioning devices which, in the respective holding position, secure the third platform against moving along and/or transversely to the longitudinal direction of the conveying slots (XY direction). This prevents the third platform from shifting in the plane (XY plane) in which the upper sides of the first, second and third platforms substantially lie.

The holding devices can for example each be designed both as supporting devices and as positioning devices. Each of the supporting devices can thus secure the third platform both downwards in the direction of gravity and against moving along and transversely to the longitudinal axis of the conveying slots. Such a holding device can for example be embodied as a (centring) bolt, in particular one which is mounted in a sliding manner, which as a fitted bolt fixes the third platform in relation to the first and/or second platform in a positive fit. Such a holding device can be arranged on each of the first and second platforms, wherein a bolt receptacle is provided on the third platform, which the bolt engages in a positive fit in its respective holding position, wherein the bolt is disengaged from the bolt receptacle when it is moved into its respective release position.

In view of the fact that the loads on the third platform which are to be expected are greater in the direction of gravity (Z direction) than along or transversely to the longitudinal direction of the conveying slots (XY direction), it can be advantageous to design some of the holding devices as supporting devices and some of the other holding devices as positioning devices. The holding devices can then be optimised for the respective load scenario. Holding devices designed as supporting devices and holding devices designed as positioning devices can for example be respectively arranged alternately along the first conveying slot and/or along the second conveying slot.

For each conveying slot, a holding device designed as a positioning device can for example be arranged between two holding devices designed as supporting devices. Alternatively or additionally, a holding device designed as a supporting device can be arranged between two holding devices designed as positioning devices. In developments, groups of holding devices which are arranged along the conveying slot(s) can be provided, wherein each group consists of two holding devices designed as supporting devices and one holding device designed as a positioning device and arranged between the two holding devices of the same group which are designed as supporting devices.

Such arrangements of differently designed holding devices advantageously ensure that the third platform is held securely, even when some of the holding devices are in the release position, in order to enable the workpiece to move along the transport path.

In developments, at least some of the holding devices, in particular the holding devices designed as supporting devices, can comprise a support on which at least one roller is arranged via which the third platform is supported in the direction of gravity. The roller can for example rest against the lower side of the third platform and/or roll off on the lower side of the third platform when the holding device moves from the holding position to the release position or from the release position to the holding position. Rolling both reduces the force required to move the holding device and reduces wear. Alternatively or additionally, the holding devices designed as positioning devices can comprise a support or at least one roller via which the third platform is supported.

The support, which can be embodied to be elongated or for example arm-shaped can preferably be pivoted about a pivot axis. The pivot axis can in particular be perpendicular or normal to the plane in which the upper side of the platform, to which the holding device is pivotably fastened, is arranged. Alternatively, the pivot axis can be arranged parallel to the longitudinal direction of the conveying slots.

The pivotable holding device can comprise a pivot bearing which forms the pivot axis and the connection between the support and the first or second platform. The support can comprise a first portion and a second portion. The first portion and the second portion can protrude from the pivot axis on both sides or in opposite directions. A roller can be arranged on each of the first and second portions. The third platform can be supported via one of the rollers, wherein the other of the rollers is supported on the first or second platform, i.e. on the platform on which the respective holding device is pivotably arranged, when the holding device is situated in its holding position. Supporting them in this way advantageously allows the (gravitational) force exerted by the third platform on one roller to be channelled via the other roller into the first or second platform, which enables the portion of the holding device which forms the pivot axis, in particular the pivot bearing, to be embodied more simply, since it does not have to absorb any torque or less torque than in an embodiment in which the holding device protrudes from the pivot axis on one side only and the third platform is supported on the support which protrudes from the pivot axis on one side. Such embodiments comprising a support which protrudes from the pivot axis on one side are nonetheless conceivable.

The at least one roller of the holding device can be able to rotate about a roller axis relative to the support. The roller axis can be arranged radially with respect to the pivot axis of the holding device and/or a longitudinal direction of the support which is in particular arm-shaped. This advantageously ensures that the at least one roller rolls off on the third platform or the first or second platform when the holding device or the support is pivoted about the pivot axis.

In developments, some of the holding devices, in particular holding devices designed as positioning devices, can comprise a positioning head which co-operates with a positioning receptacle formed on the third platform, such that the third platform is secured against moving in particular along or transversely to the transport direction (X or Y direction) when the respective holding device is situated in its holding position. These holding devices can for example be able to linearly move between the holding position and the release position. In particular, the positioning head can be moved into engagement with the positioning receptacle as the holding device moves from the release position to the holding position. The positioning head can be moved out of engagement with the positioning receptacle as the holding device moves from the holding position to the release position.

The positioning head can be arranged on an elongated structure, in particular a piston rod, which can be linearly shifted from the holding position to the release position and/or from the release position to the holding position. The holding device can be a piston-cylinder unit comprising a piston rod which can be retracted and extended from a housing. The positioning head can be arranged on the free end of the piston rod, i.e. the end which can be extended and retracted. When the piston rod is extended, it moves into the holding position. When the piston rod is retracted, it moves into the release position.

Generally, at least one actuating member and in particular one actuating member for each holding device can be provided which is configured to move the respective holding device from the holding position to the release position and/or from the release position to the holding position. In particular, a controller can be provided which is configured to initiate actuating members or the aforementioned actuating members such that the holding devices are moved from the holding position to the release position and/or from the release position to the holding position.

Ideally, the controller is configured such that it causes at least the holding device(s) situated in front of a connecting structure in the transport direction to be moved from the holding position to the release position, and/or the holding device which a connecting structure has passed in the transport direction or which is situated behind the connecting structure in the transport direction to be moved from the release position to the holding position. Advantageously, the controller is configured such that it causes the other holding devices to be or remain in their respective holding position during this time. Such an embodiment ensures that only the holding devices which would block the connecting structure from moving are moved out of the holding position, wherein the other holding structures hold the third platform in position.

The holding device can for example be moved from the holding position to the release position and/or from the release position back to the holding position by means of a sensor or mechanically by means of a spring or surfaces which slide off on each other.

The assembly station can for example comprise a device, in particular at least one sensor or a navigation device, which is adapted to ascertain a position, in the transport direction, of the transport device or a connecting structure which extends through at least one of the conveying slots, wherein the controller is adapted to initiate individual holding devices or their actuating members in accordance with the position in the transport direction, such that these holding devices are moved from the holding position to the release position and/or from the release position to the holding position. The sensor can for example be a magnetic switch, a magnetic contact, a microswitch, an inductive sensor, a capacitive sensor, a light barrier comprising a photocell, or the like. The device and/or navigation device can for example comprise a so-called indoor GPS or an image processing device including one or more cameras.

The holding devices or at least some of the holding devices can be configured such that they are moved, in particular mechanically, from the holding position to the release position and/or from the release position to the holding position by an activating device which moves together with the transport device. A surface of the activating device can for example slide off on the holding device or on a surface formed on the holding device, wherein moving the activating device moves the holding device from the holding position to the release position. It can also be returned to the holding position by an activating device or by an elastic element.

In developments, the holding device can comprise an elastic element, such as for example a spring or a biased spring, which is tensioned or further tensioned when the holding device moves from the holding position to the release position and moves the holding device from the release position back to the holding position, in particular when an activating device which moves together with the transport device and has moved the holding device from the holding position to the release position releases the holding device to move back to the holding position. The spring can for example be a mechanical spring, such as for example a tensile spring or compression spring or a torsion spring or a gas spring. The holding device can advantageously comprise, in addition to the elastic element, an attenuator element which attenuates the movement of the holding device from the release position back to the holding position. This minimises noise on the one hand and wear on the other.

The transport device can for example be designed such that it is supported on the assembly station, in particular in addition to being supported on the floor by means of its wheels, such that the transport device is prevented from tilting, in particular laterally. To this end, the transport device can expediently be supported upwards. The transport device can for example be supported on the first and/or second platform or on one or more of the holding devices, in particular at least one holding device for the first conveying slot and/or at least one holding device for the second conveying slot, for example by means of sliding bearings or roller bearings, as it moves through the assembly station. The transport device can comprise at least one sliding rail via which it is supported on at least one holding device, in particular one designed as a supporting device, for example on the lower side of the holding device. The sliding rail can comprise a contact surface made of a friction-reducing material, such as for example polytetrafluoroethylene (PTFE) or generally a plastic. The transport device can comprise: a first sliding rail via which it is supported on the side of the first conveying slot, in particular on at least one of the holding devices for the first conveying slot; and a second sliding rail via which it is supported on the side of the second conveying slot, in particular on at least one of the holding devices for the second conveying slot. The additional support traps or positively guides the transport device between the floor and the assembly station, which prevents the transport device from tilting as it moves through the assembly station.

An aspect of the invention also relates to an assembly system comprising an assembly station as presently described and a transport device which is designed as a vehicle, in particular an automated driverless and in particular autonomous transport vehicle. The vehicle comprises wheels on which the transport device can move on a floor or on the transport path situated below the third platform. The transport device and the workpiece arranged above the third platform are connected to the transport device via at least one connecting structure which extends through the first conveying slot or through the second conveying slot or through the first and second conveying slot. The holding structures, when they are in their respective release position, enable the connecting structures to move along the transport path in the transport direction in the conveying slots. The holding structures which are situated in their holding position hold the third platform such that it cannot shift or move in relation to the first and second platforms.

An aspect of the invention also relates to a method for operating an assembly station, in particular an assembly station as presently described, and/or an assembly system, in particular an assembly system as presently described. As described above, the assembly station comprises a plurality of holding devices which, in their respective holding position, hold the third platform in position in relation to the first or second platform. One or more of the holding devices is/are moved from the holding position to a release position, as the transport device moves through the assembly station, in order to enable the transport device together with the workpiece to move through the assembly station. During this time, one or more of the holding devices is/are in the respective holding position in order to hold the third platform in position. Developments of the method may be derived from the description of the assembly station and/or assembly system.

### BRIEF DESCRIPTION OF THE DRAWINGS

An aspect of the invention has been described on the basis of a plurality of examples and embodiments. An example embodiment is described below on the basis of figures. The features thus disclosed, individually and in any combinations of features, advantageously develop the subject matter of the claims. There is shown:

FIG. 1 an assembly platform together with workpieces and transport devices, in a perspective view;

FIG. 2 the assembly platform shown in FIG. 1, in a side view;

FIG. 3 the view shown in FIG. 2, without the workpiece or transport device;

FIG. 4 a holding device designed as a positioning device;

FIG. 5 a holding device designed as a supporting device;

FIG. 6 the assembly platform shown in FIG. 1, in a view from below, wherein the holding devices are situated in their holding positions;

FIG. 7 the view shown in FIG. 6, wherein two of the holding devices are situated in a release position;

FIG. 8 a perspective view of a development of the holding device shown in FIG. 4, in a holding position;

FIG. 9 the holding device shown in FIG. 8, in a release position; and

FIG. 10 a modification of the assembly platform shown in FIG. 1, in a view from below, wherein the holding devices are situated in their holding positions.

### DETAILED DESCRIPTION OF EXEMPLARY EMBODIMENTS

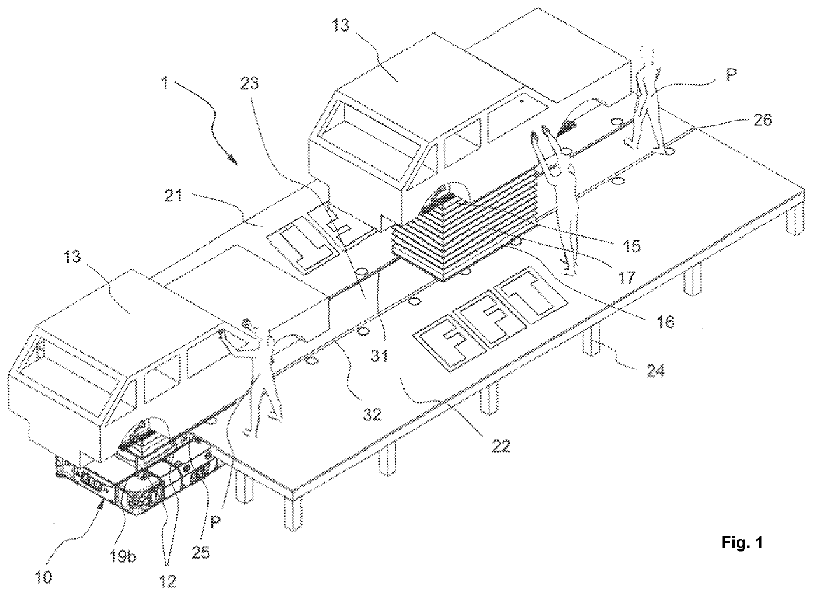

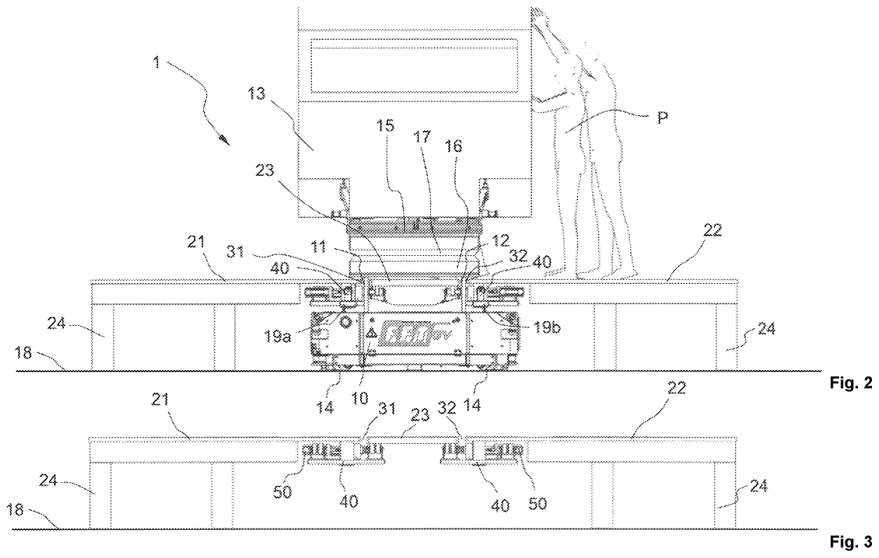

The assembly station shown in FIGS. 1 to 3 is designed as an assembly platform and serves to enable machine operators or assembly operators, referred to generally as persons, to work on a workpiece. In the example shown, the workpieces are the body of a motor vehicle, to which the person adds further attachment parts. Although the workpiece shown is a vehicle body, an aspect of the invention is not necessarily limited to an assembly station for working on vehicle bodies, but rather is suitable generally for workpieces manufactured in series production, in particular assembly-line production, which can for example be household appliances, heat pumps, oil heaters, gas heaters, pellet heaters, vehicles or the like. The workpiece is connected to a transport device via at least one first connecting structure and at least one second connecting structure. The transport device is an autonomous or driverless transport vehicle (automated guided vehicle or AGV). The transport vehicle comprises wheels (FIG. 2) via which it can move or roll off on a floor or transport path. The transport device normally comprises a battery, a controller and an extensive system of sensors for determining its spatial position. The transport device can convey the workpiece to an entrance of the assembly station, transport it through the assembly station from the entrance to an exit and convey it away from the exit of the assembly station. The advantage of this is that the workpiece does not have to be transferred from the transport device in order to be worked on in the assembly station, but rather remains on the transport device.

In the example shown, and as is most clearly shown in FIGS. 1 and 2, the workpiece is arranged on a workpiece support. Optionally, and as shown in FIG. 1, the workpiece support can be height-adjustable in relation to the assembly station or the transport device, such as for example by means of a scissor joint or generally a lifting device. The connecting structures connect the transport device to a base, wherein the lifting device, which is clad in a skirt, is arranged between the base and the workpiece support and can raise and lower the workpiece or workpiece support relative to the base, as shown for example in FIG. 1. Embodiments in which a height adjustment is not required, such that a lifting device may be regarded as optional, are in principle also conceivable.

The assembly station comprises a first accessible platform, a second accessible platform and a third accessible platform. The upper sides of the accessible platforms lie in or at least approximately in a common horizontal plane. This enables the persons to move on the platforms with minimal risk of tripping. The platforms are for example elevated or raised above the floor, or a transport path along which the transport device can move, via a frame. This enables the conveying device to pass through below the platforms, in particular the third platform, in the transport direction on a defined transport path from the entrance to the exit. The conveying device moves the workpiece through the assembly station.

The third platform is arranged between the first platform and the second platform (FIGS. 1 to 3, 6, 7 and 10). A first conveying slot is formed between the first and third platforms. A second conveying slot is formed between the second and third platforms. The longitudinal directions of the conveying slots define the transport path. The at least one first connecting structure, which connects the workpiece to the transport device, extends through the first conveying slot. The at least one second connecting structure, which connects the workpiece to the transport device, extends through the second conveying slot. The at least one first connecting structure and the at least one second connecting structure are arranged at a distance transversely to the transport direction or transport path, in order to increase the stability of the workpiece or workpiece support in relation to the transport device. The third platform is provided in order to enable the persons to safely cross the region between the first connecting structure and the second connecting structure and/or between the first and second platforms. As the transport device moves through the assembly station, the at least one first connecting structure moves through the first conveying slot and the at least one second connecting structure moves through the second conveying slot. Since the third platform is separated from the first and second platforms due to the conveying slots and cannot be supported directly on the floor via a fixed frame below the third platform due to the transport device passing through, holding devices are provided (FIGS. 2 and 3) which are each configured to be able to assume a holding position in which they cross one of the conveying slots and hold the third platform in position in relation to the first or second platform. In the examples shown in the figures, a plurality of holding devices which are provided in order to bridge the first conveying slot are movably arranged on the first platform. In order to bridge the second conveying slot, a plurality of holding devices are provided which bridge the second conveying slot and are movably arranged on the second platform. The holding devices are movably arranged on the lower side of the first platform and/or second platform, as shown for example in FIGS. 2, 3, 6, 7 and 10.

In one example embodiment, the holding devices are embodied differently in accordance with their function and the associated loads. As is most clearly shown in FIGS. 3, 6, and 7, holding devices are provided which are designed as supporting devices (FIG. 5) and which, in the respective holding position, support the third platform at least downwards in the direction of gravity (Z direction), i.e. the supporting devices 40 primarily serve to prevent the third platform from falling down and/or to keep the third platform in a common horizontal plane with the first and second platforms.

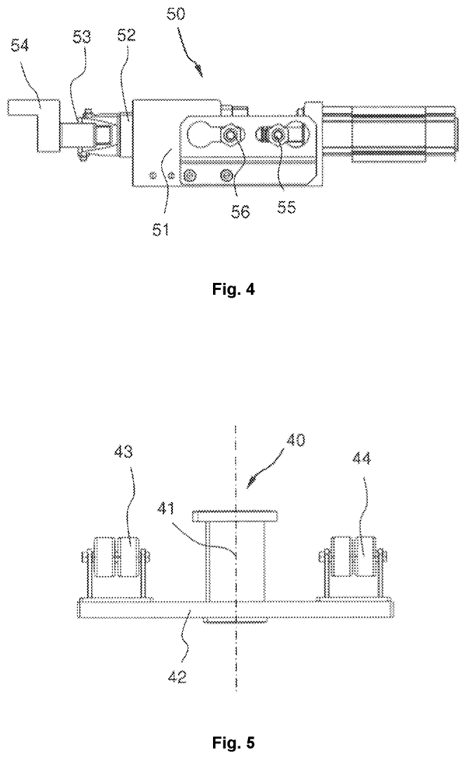

Holding devices are also provided which are designed as positioning devices (FIG. 4) and which, in the respective holding position, secure the third platform against moving in the longitudinal direction of the conveying slots (X direction) and/or transversely to the longitudinal direction of the conveying slots (Y direction). The positioning devices serve to prevent the third platform from moving in the horizontal plane (XY direction) of the first and second platforms. Since the loads on the third platform which are to be expected may be expected to be smaller in the XY direction or horizontal plane than in the Z direction, the holding devices are optimised for the respective load scenario.

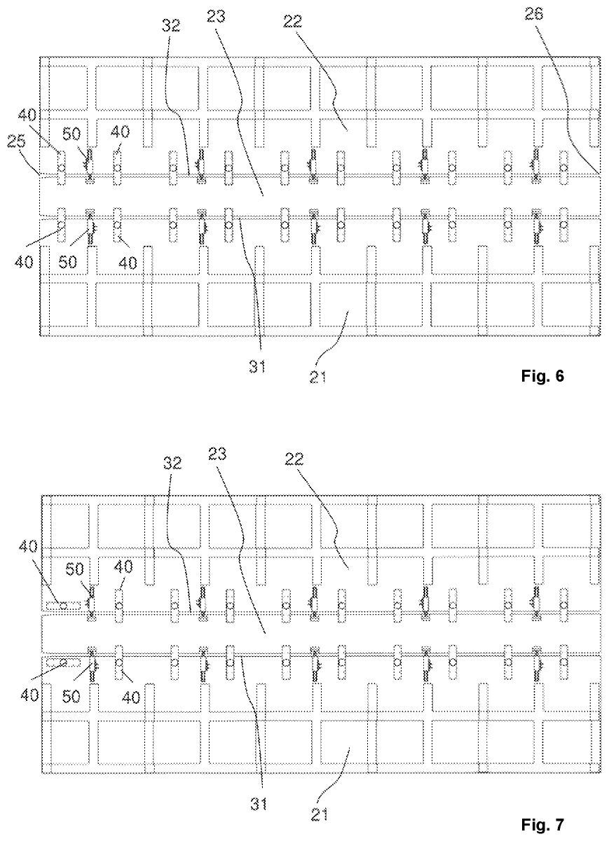

As shown in FIG. 5, the supporting devices exhibit a pivot axis and comprise a corresponding pivot bearing on the lower side of the first platform and/or the second platform. The supporting device 40 also comprises a support, in particular an arm-shaped support, which comprises a first portion and a second portion. The first portion and the second portion protrude radially from the pivot axis in opposite directions. A roller which points towards the platform or upwards is arranged on the first portion. Similarly, a roller which points towards the platform or upwards is arranged on the second portion. When the supporting device is in the holding position, which is shown for example in FIG. 2, the third platform is supported in the direction on the supporting device via the roller. The torque generated by the distance between the roller and the pivot axis is absorbed by the roller which is supported on the lower side of the first platform or the second platform, i.e. the platform to which the respective supporting device is pivotably fastened. The rotational axes of the rollers are arranged substantially radially, i.e. perpendicular to the pivot axis. In order to move the supporting device from its holding position (FIGS. 2 and 6) to the release position, the support together with the rollers is pivoted about the pivot axis, whereby the rollers roll off on the third platform or, respectively, the first platform or the second platform. FIG. 7 shows two supporting devices (cf. FIG. 6) in their release position, wherein the remaining supporting devices are or remain in their holding position.

When the supporting devices are moved from their respective holding position to the release position, for example by an electric motor, hydraulically or pneumatically, or mechanically by means of the transport device which moves through the assembly station, the rollers are situated below the first platform and/or the second platform, as is the support. The supporting device, in its release position, thus exposes and/or no longer crosses the conveying slot which it crosses in its respective holding position. The connecting structures can thus move through their respective conveying slot without being blocked by the supporting device. The supporting devices can for example be moved back to the holding position by a spring element which is tensioned during the movement from the holding position to the release position, or by an electric motor, hydraulically or pneumatically.

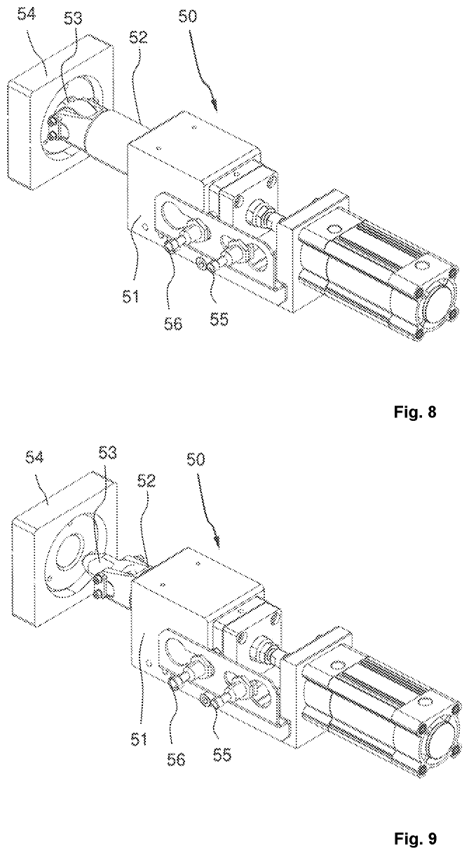

An embodiment of a holding device designed as a positioning device is shown in particular in FIG. 4. The embodiment of a holding device shown in FIGS. 8 and 9 is structured in substantially the same way as that of FIG. 4, except that with regard to the embodiment of the positioning head and positioning receptacle, it is configured such that in addition to positioning in the X and Y directions, it can also provide support in the Z direction.

The positioning devices are designed as piston-cylinder units comprising a housing, which is fastened to the lower side of the first platform for the first conveying slot or the lower side of the second platform for the second conveying slot, and a piston rod which can be retracted and extended from the housing, in particular pneumatically or alternatively by an electric motor or hydraulically. Each positioning device is also assigned a positioning receptacle which is fastened to the lower side of the third platform. When the piston rod is in an extended position, a positioning head which is arranged at the free end of the piston rod, i.e. the end which can be extended and retracted, is in engagement with the positioning receptacle and thus in a holding position in which the positioning head co-operates with the positioning receptacle such that the third platform is secured at least against moving in the XY direction (FIG. 4) or against moving in the X, Y and Z directions (FIGS. 8 and 9). When the piston rod is retracted from the holding position shown for example in FIGS. 3, 6, 7 and 8 into the housing (FIG. 9), the engagement between the positioning head and the positioning receptacle is released. When the piston rod is retracted, it exposes the conveying slot, which enables the connecting structures to move in the transport direction through their respective conveying slot. The holding device comprises at least one port, such as for example a first port and a second port, via which it can be supplied with electrical energy, compressed air or hydraulic fluid. The embodiments shown in FIGS. 4, 8 and 9 comprise a dual-function piston-cylinder unit, wherein (compressed) fluid (compressed air or hydraulic fluid) is supplied via a first port and simultaneously discharged via a second port when the piston rod is to be extended and/or moved into its holding position. When the piston rod is to be retracted and/or moved into its release position, (compressed) fluid is supplied to the piston-cylinder unit via the second port and simultaneously discharged via the first port.

As is most clearly shown in FIGS. 8 and 9, the positioning receptacle comprises a cavity, in particular a drilled hole, for receiving the positioning head which is designed as a centring body. The positioning head is conical at its end pointing towards the positioning receptacle or tapered towards its free end. This advantageously ensures that the positioning head can be securely moved into the cavity or into the holding position even when the centre axes of the positioning head and the cavity are slightly out of alignment, as can for example be the case when the platforms are deformed in the Z direction, i.e. the direction of gravity, by a load acting on the platform. In the example shown, the piston rod is bifurcated at the end pointing towards the positioning receptacle in order to receive the positioning head. The positioning head is received between the limbs of the bifurcation and bolted to the limbs by means of threaded bolts. In other modifications, the holding device shown in FIG. 4 can be replaced with the holding device shown in FIGS. 8 and 9 in the arrangement shown in FIGS. 6 and 7. The holding device shown in FIGS. 8 and 9 can be combined with the holding devices.

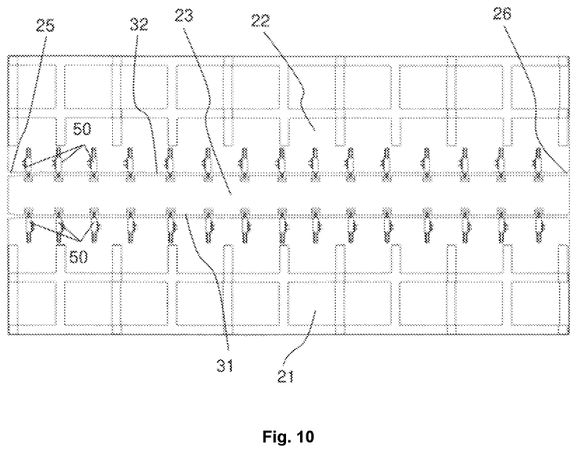

In the modification shown in FIG. 10 (made relative to the embodiment shown in FIGS. 6 and 7), the holding devices (such as for example the holding device shown in FIGS. 8 and 9) are designed such that they can perform the function of positioning in the XY direction and the function of holding in the Z direction. This modification does not require holding devices which are specifically designed as supporting devices, such as for example those shown in FIG. 5.

The holding devices (FIGS. 6 and 7) or (FIG. 10) are configured or controlled by a controller such that a plurality of holding devices, in particular a plurality of supporting devices and a plurality of positioning devices in the embodiment shown in FIGS. 4 and 5 or a plurality of holding devices in the embodiment shown in FIG. 10, are always in their holding position simultaneously. The holding devices, in particular the supporting devices and/or the positioning devices, are configured or controlled by a controller such that the maximum number of holding devices which are in or can be moved into the release position is such that the third platform is securely held in position, i.e. in the X, Y and Z directions, by the holding devices situated in the holding position.

In order to secure it against tilting laterally, the transport device comprises a first sliding rail and a second sliding rail, in particular on its side pointing upwards and/or towards the platforms, wherein the transport device is supported upwards on the first platform and the second platform via said rails, in addition to being supported on the floor by means of its wheels. In the example shown, the sliding rails are supported on the holding devices designed as supporting devices and in particular indirectly on the first and second platforms (FIG. 2). The first sliding rail is supported on the holding devices assigned to the first conveying slot. The second sliding rail is supported on the holding devices assigned to the second conveying slot. The sliding rails can slide along the holding devices when the transport device moves through the assembly station.

List of reference signs

| | |
|---|---|
| 1 | assembly station |
| 10 | transport device |
| 11 | first connecting structure |
| 12 | second connecting structure |
| 13 | workpiece |
| 14 | wheel |
| 15 | workpiece support |
| 16 | base |
| 17 | lifting device |
| 18 | floor |
| 19a | first sliding rail |
| 19b | second sliding rail |
| 21 | first platform |
| 22 | second platform |
| 23 | third platform |
| 24 | frame |
| 25 | entrance |
| 26 | exit |
| 31 | first conveying slot |
| 32 | second conveying slot |
| 40 | holding/supporting device |
| 41 | pivot axis |
| 42 | support |
| 43 | roller |
| 44 | roller |
| 50 | holding/positioning device |
| 51 | housing |
| 52 | piston rod |
| 53 | positioning head |
| 54 | positioning receptacle |
| 55 | first port |
| 56 | second port |
| P | person |

1. An assembly station through which a workpiece arranged on a transport device can be moved on a defined transport path in a transport direction, the assembly station comprising:
a first, second and third accessible platform, wherein the third platform is arranged between the first platform and the second platform;
a first conveying slot, which is formed between the first and third platforms, and a second conveying slot which is formed between the second and third platforms, wherein the longitudinal directions of the conveying slots define the transport path; and
a plurality of holding devices which are each configured to be able to assume a holding position in which they for example cross one of the conveying slots and hold the third platform in position in relation to the first or second platform,
wherein the holding devices are configured to be moved into a release position in which they enable the transport device together with the workpiece to move through the assembly station or expose or do not cross the conveying slot which they cross in their respective holding position.

2. The assembly station according to the claim 1, wherein:
a plurality of holding devices, in their holding position, cross the first conveying slot and hold the third platform in position in relation to the first platform and, in their release position, expose or do not cross the first conveying slot; and
a plurality of holding devices, in their holding position, cross the second conveying slot and hold the third platform in position in relation to the second platform and, in their release position, expose or do not cross the second conveying slot.

3. The assembly station according to claim 1, wherein the holding devices, in their respective release position, enable at least one connecting structure, which connects the transport device, which can be moved along the transport path below the third platform, to the workpiece, which is arranged above the third platform, and extends through the first and/or second conveying slot, to move in the conveying slot along the transport path in the transport direction.

4. The assembly station according to claim 1, wherein the holding devices are configured such that a plurality of the holding devices are always simultaneously in their holding position.

5. The assembly station according to claim 1, wherein the holding devices are configured such that the maximum number of holding devices which are in or can be moved into the release position is such that the third platform is held in position by holding devices situated in the holding position.

6. The assembly station according to claim 1, wherein the holding devices or at least some of the holding devices can be linearly moved between the holding position and the release position.

7. The assembly station according to claim 1, wherein the holding devices or at least some of the holding devices can be pivoted about a pivot axis between the holding position and the release position.

8. The assembly station according to claim 1, wherein at least some of the holding devices are designed as supporting devices which, in the respective holding position, support the third platform at least downwards in the direction of gravity.

9. The assembly station according to claim 1, wherein at least some of the holding devices are designed as positioning devices which, in the respective holding position, secure the third platform against moving along and/or transversely to the longitudinal direction of the conveying slots.

10. The assembly station according to claim 8, wherein holding devices designed as supporting devices and holding devices designed as positioning devices are respectively arranged alternately along the first conveying slot and/or along the second conveying slot.

11. The assembly station according to claim 1, wherein at least some of the holding devices designed as supporting devices, comprise a support on which at least one roller is arranged via which the third platform is supported.

12. The assembly station according to claim 11, wherein the support, which is an arm-shaped support, can be pivoted about a pivot axis, wherein a first and second portion of the support protrude from the pivot axis on both sides, wherein a roller is arranged on each portion, wherein the third platform is supported via one of the rollers, wherein the other of the rollers is supported on the first platform or second platform when the holding device is situated in its holding position.

13. The assembly station according to claim 11, wherein the at least one roller can be rotated relative to the support about a roller axis which is arranged parallel to a longitudinal direction of the arm-shaped support.

14. The assembly station according to claim 1, wherein at least some of the holding devices designed as positioning devices, comprise a positioning head which co-operates with a positioning receptacle formed on the third platform, such that the third platform is secured against moving when the holding device is situated in its holding position.

15. The assembly station according to claim 14, wherein the positioning head is arranged on a piston rod, which can be linearly shifted from the holding position to the release position and/or from the release position to the holding position.

16. The assembly station according to claim 14, wherein the holding devices comprise a piston-cylinder unit comprising a piston rod which can be retracted and extended from a housing, wherein the positioning head is arranged on the piston rod.

17. The assembly station according to claim 1, further comprising a controller which is configured to initiate actuating members such that the holding devices are moved from the holding position to the release position and/or from the release position to the holding position.

18. The assembly station according to claim 3, further comprising a controller which is configured to initiate actuating members such that at least the holding devices situated in front of the connecting structure in the transport direction are moved from the holding position to the release position, and/or the holding device which the connecting structure has passed or which is situated behind the connecting structure is moved from the release position to the holding position.

19. The assembly station according to claim 17, further comprising at least one sensor, which is adapted to ascertain a position, in the transport direction, of the transport device or a connecting structure which extends through at least one of the conveying slots, wherein the controller is adapted to initiate individual holding devices or their actuating members in accordance with the position in the transport direction, such that these holding devices are moved from the holding position to the release position and/or from the release position to the holding position.

20. The assembly station according to claim 1, wherein the holding devices or at least some of the holding devices are configured such that they are moved, mechanically, from the holding position to the release position and/or from the release position to the holding position by an activating device which moves together with the transport device.

21. The assembly device according to claim 1, wherein the holding device comprises an elastic element, for example a spring, which is tensioned when the holding device moves from the holding position to the release position and moves the holding device from the release position back to the holding position.

22. An assembly system comprising an assembly station according to claim 1 and a transport device which is designed as a vehicle comprising wheels and connecting structures which connect the transport device, which can be moved on the wheels along the transport path below the third platform, to the workpiece which is arranged above the third platform, wherein one of the connecting structures extends through the first conveying slot and another of the connecting structures extends through the second conveying slot, wherein the holding structures, when in their release position, enable the connecting structures to move along the transport path in the transport direction in the conveying slots.

23. A method for operating an assembly station according to claim 1, the assembly station comprising:
a first, second and third accessible platform, wherein the third platform is arranged between the first platform and the second platform;
a first conveying slot, which is formed between the first and third platforms, and a second conveying slot which is formed between the second and third platforms, wherein the longitudinal directions of the conveying slots define the transport path; and
a plurality of holding devices which, in a holding position, hold the third platform in position in relation to the first or second platform,
wherein one or more of the holding devices is/are moved from the holding position to a release position in order to enable the transport device together with the workpiece to move through the assembly station, and one or more of the holding devices are in the holding position during this time in order to hold the third platform in position.

24. The assembly station according to claim 9, wherein holding devices designed as supporting devices and holding devices designed as positioning devices are respectively arranged alternately along the first conveying slot and/or along the second conveying slot.

25. The assembly station according to claim 15, wherein the holding devices comprise a piston-cylinder unit comprising a piston rod which can be retracted and extended from a housing, wherein the positioning head is arranged on the piston rod.

26. The assembly station according to claim 18, further comprising at least one sensor, which is adapted to ascertain a position, in the transport direction, of the transport device or a connecting structure which extends through at least one of the conveying slots, wherein the controller is adapted to initiate individual holding devices or their actuating members in accordance with the position in the transport direction, such that these holding devices are moved from the holding position to the release position and/or from the release position to the holding position.
